(19) United States
(12) Patent Application Publication
(10) Pub. No.: US 2005/0236898 A1
(43) Pub. Date: Oct. 27, 2005

(54) Protective chain for endless drive-belts

(76) Inventor: Herbert Devon Gunter, North Manchester, IN (US)

Correspondence Address: BARNES & THORNBURG, 11 SOUTH MERIDIAN, INDIANAPOLIS, IN, 46204, US

(21) Appl. No.: 11/111,621

(22) Filed: Apr. 21, 2005

Related U.S. Application Data
(60) Provisional application No. 60/565,185, filed on Apr. 26, 2004.

(51) Int. Cl. B62D 55/12

(52) U.S. Cl. 305/195

(57) ABSTRACT

A drive track system for a work machine includes a rubber drive-belt and a metal chain configured to cover and protect an outer surface of the rubber drive-belt. The chain may include multiple, interconnected U-shaped bars which each define a recess formed to receive a portion of the rubber drive-belt therein.

This application claims priority to U.S. Provisional Patent Application Ser. No. 60/565,185 titled “Tracks Over Tracks” which was filed on Apr. 26, 2004 by Herbert Devon Gunter, the entirety of which is expressly incorporated by reference herein.

### FIELD OF THE DISCLOSURE

The present disclosure relates generally to work machines, and more particularly to work machines having rubber, ground-engaging, endless drive tracks.

### BACKGROUND

Rubber ground-engaging endless drive tracks or belts are commonly used on various all-terrain loaders or work machines. The lifespan of these rubber belts may be compromised when such rubber belts are used in areas with significant ground clutter and/or areas having a rough or rugged terrain. For example, the edges of the rubber belts may become cut or torn due to the ground clutter and specifically due to ground clutter having sharp edges.

Typically, rubber belts engage a drive wheel of the work machine. Additionally, a typical rubber belt includes a guide block which engages a corresponding guide slot in the wheels to provide lateral guidance to the rubber belt as the rubber belt is driven around the wheels. Maintaining the guide block of the rubber belt within the corresponding guide slot oftentimes requires that the rubber track be under tension as the rubber track is advanced around the wheels of the work machine. This tension may cause the rubber belt to stretch with use over time. This stretching may, in turn, affect the lifespan of the rubber belt.

### SUMMARY

The present invention comprises one or more of the features recited in the appended claims or the following features or combinations thereof:

According to one aspect of the disclosure, a drive track system for a work machine includes a drive belt adapted to be coupled to the work machine and a chain engaged with an outer surface of the drive-belt. The chain includes a plurality of interconnected, transverse members each of which extends across a width of the drive belt. The chain may further include first and second flanges coupled an outer end of each of the transverse members. The first and second flanges may be arranged in a non-perpendicular orientation relative to the respective transverse member to which each are coupled or may be generally perpendicular to the transverse member.

The drive track system may also include a plurality of connecting links coupled to each other and to each transverse member to position the transverse members in spaced-apart relation to each other.

In another aspect of the disclosure, a method of operating a belt-driven work machine includes covering an outer surface of a rubber drive-belt of the belt-driven work machine with a metal chain including a plurality of interconnected U-shaped bars to position the rubber drive-belt within a recess defined by each U-shaped bar.

In yet another aspect of the disclosure, a chain adapted to be positioned on a rubber drive-belt of a belt-driven work machine includes a plurality of interconnected U-shaped bars. Each bar includes a transverse member and a pair of flanges extending downwardly from the transverse member to define a recess adapted to receive a portion of the rubber drive-belt of the belt-driven work machine. In an exemplary embodiment, the U-shaped bars are metal. Further, illustratively, a profile of each flange may be generally shaped to form a trapezoid. For example, a connecting end of each flange, which is coupled to the transverse member, may have a first depth smaller than a second depth of a free end of each flange.

The above and other features of the present disclosure will become apparent from the following description and the attached drawings.

### BRIEF DESCRIPTION OF THE DRAWINGS

The detailed description particularly refers to the accompanying figures in which:

FIG. 1 is a diagrammatic view of a belt-driven work machine showing a typical prior art rubber belt of the machine;

FIG. 2 is a diagrammatic view of a protective chain of the present disclosure coupled to the rubber belt of the belt-driven work machine shown in FIG. 1;

FIG. 3 is a sectional view of the protective chain and the rubber belt of FIG. 2 showing a “U-shaped” bar of the chain and connecting links coupled to the bar to connect each bar to an adjacent bar thereby forming the protective chain; and

FIG. 4 is an end view of the U-shaped bar shown in FIG. 3 showing a profile of a flange of the U-shaped bar being generally shaped to form a trapezoid.

### DETAILED DESCRIPTION OF THE DRAWINGS

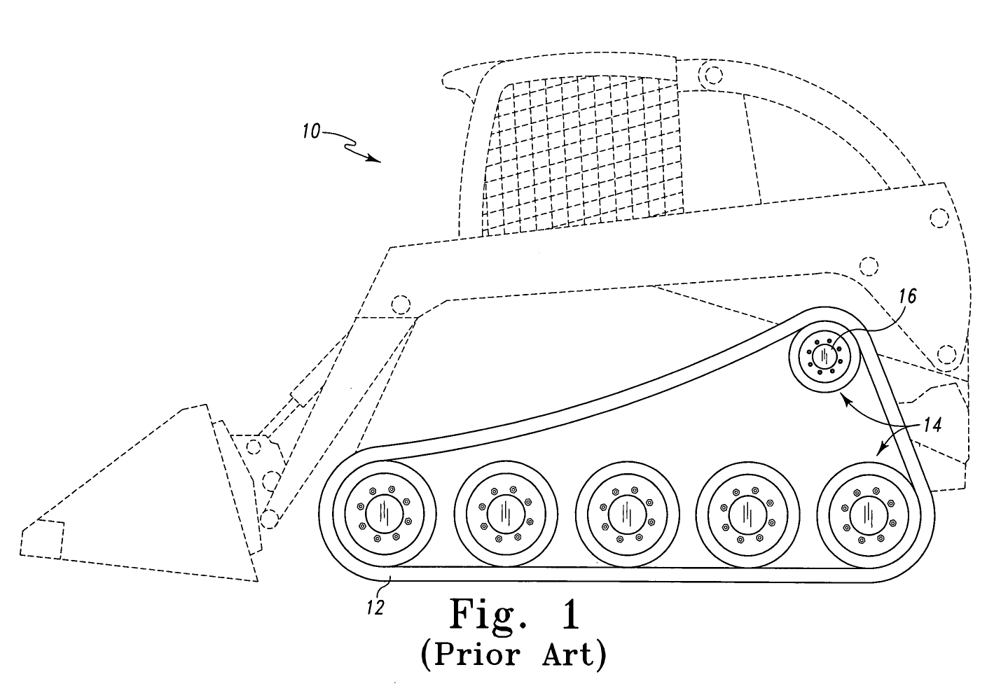

Referring now to FIG. 1, there is shown a work machine such as a belt-driven skid steer 10 which is used to perform numerous work functions such as earth moving and material loading. As used herein, the term “belt-driven” is intended to mean that the skid-steer, or any work machine, is propelled by a drive system which includes an undercarriage assembly that includes a drive sprocket that is driven by the output from an engine to drive, for example, a ground-engaging, endless, rubber drive-belt 12, as shown in FIGS. 1-3. As such, “belt-driven” work machines are contrasted from “wheel-driven” work machines which include a drive system including a pair of front wheels, rear wheels, and an engine which drives the wheels via a transmission assembly.

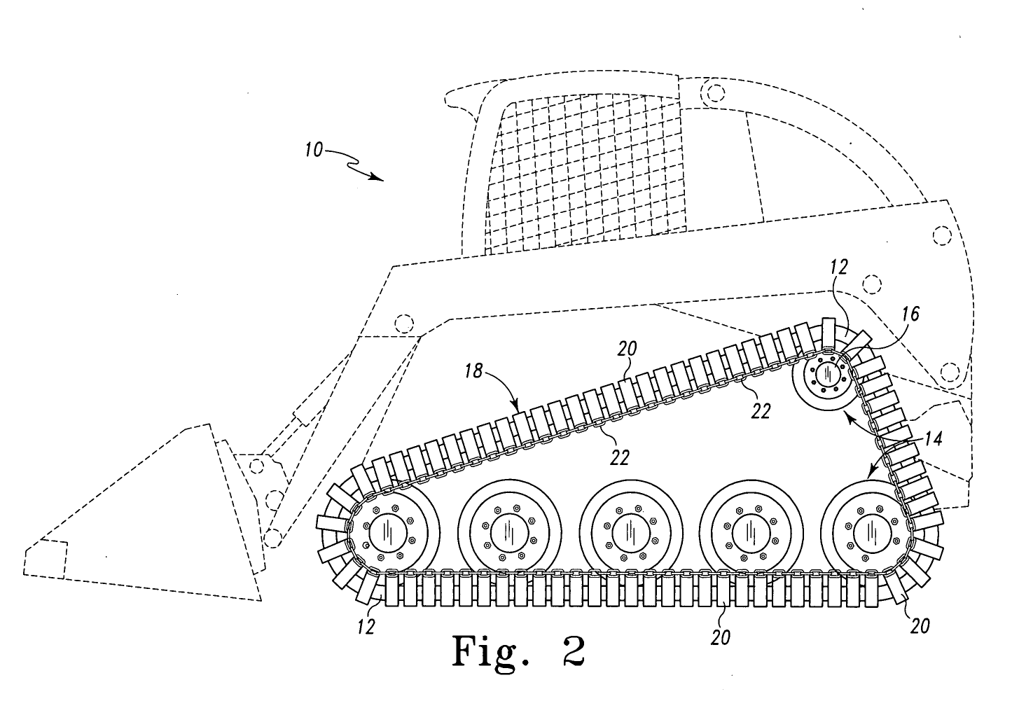

As shown in FIGS. 1 and 2, the belt-driven work machine 10 includes the rubber belt 12 and a set of wheels 14. Typically, the top wheel 16 of the set of wheels 14 is adjustable to keep the drive-belt 12 tensioned around the set of wheels 14. A protective chain 18 of the present disclosure covers or surrounds the rubber drive-belt 12, as shown in FIG. 2. The chain 18 is illustratively made of steel or some other durable metal or other suitable material and is positioned over the rubber belt 12 to protect the rubber belt 12 from wear. For example, the chain 18 operates to protect the rubber belt 12 from becoming cut or torn due to ground clutter or rough terrain, for example, which the rubber belt 12 may normally encounter.

The chain 18 further aids in preventing the rubber belt 12 from stretching due to normal use. For example, the protective chain 18 may reduce the amount of tension normally carried by the rubber belt 12 to prevent stretching of the rubber belt and potentially extend the life of the rubber belt 12. Furthermore, the chain 18 provides the belt-driven work machine 10 with additional traction for use of the work machine 10 on slippery or muddy terrain as well as wooded or rough terrain, for example. The protective chain 18 and the rubber drive belt 12 cooperate to provide a drive track system for belt-driven work machines.

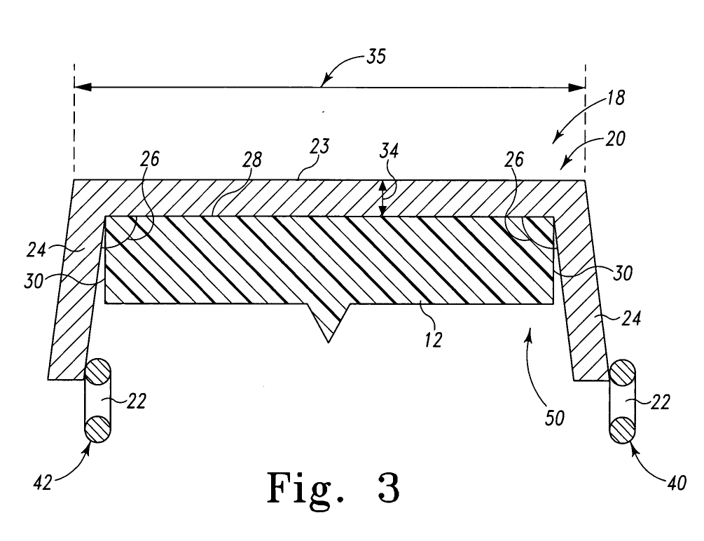

The chain 18 includes multiple bars 20 interconnected to each other by connecting links 22, as shown in FIG. 3, for example. Each bar 20 generally forms a “U-shape” and includes a transverse member 23 and two downwardly extending flanges 24 coupled the outer ends of the transverse member 23. In particular, a first flange 24 of each bar 20 is coupled to a first outer end of the transverse member 23 and a second flange 24 of each bar 20 is coupled to a second outer end of the transverse member 23. Illustratively, each of the U-shaped bars 20 of the chain 18 defines a recess 50 for receiving at least a portion of the drive-belt 12, as shown in FIG. 3. It is noted that although the flanges 24 have been described as “downwardly extending” flanges and are shown in FIG. 3 as being “downwardly extending”, the flanges 24 may be considered to extend upwardly from the transverse member 23 depending on the orientation of the bar 20.

Illustratively, each flange 24 is arranged to define a non-perpendicular orientation or relationship with the transverse member 23. Specifically, as shown in FIG. 3, an obtuse angle 26 is formed between the transverse member 23 and each of the flanges 24. This obtuse angle 26 created by the orientation of the flanges 24 relative to the transverse member 23 prevents the bars 20 from interfering with the wheels 14 of the work machine 10. It is within the scope of this disclosure however, to include bars 20 where the angle defined between the transverse member 23 and either one of the flanges 24 is acute, right (i.e., 90 degrees), or obtuse.

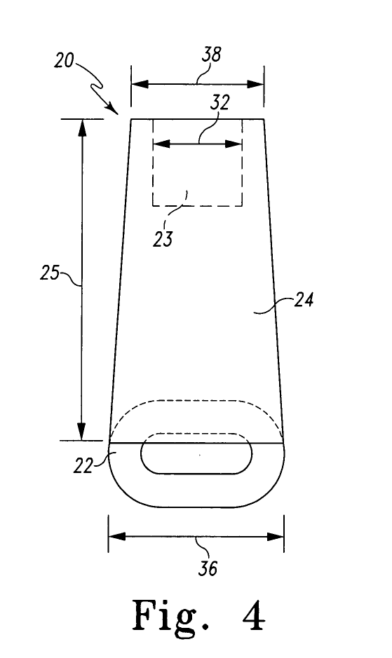

As shown in FIG. 3, the bar 20 surrounds three sides of the rubber belt 12. Specifically, the bar 20 surrounds the outer or ground-engaging surface 28 of the rubber belt 12 and each end or side surface 30 of the rubber belt 12. Illustratively, a depth 32 of the transverse member 23 (shown in FIG. 4) is approximately ⅞ inch and a thickness 34 of the transverse member 23 is also approximately ⅞ inch. The depth 32 of the transverse member 23 is generally sized to allow the chain 18 to rotate or track around the typically smaller diameter wheels provided on many belt-driven work machines. It is within the scope of this disclosure, however, for the transverse member 23 to have a larger or smaller depth and/or thickness than the illustrative embodiment shown in FIGS. 2 and 3. A width 35 of the transverse member 23 is generally sized to fit a corresponding width of the particular rubber track to be protected.

Looking now to FIG. 4, each flange 24 of the chain 18 generally has the profile of, or forms the shape of, a trapezoid when viewed from the side as shown in FIG. 3. That is, a bottom portion or free end of each flange 24 is wider than a top portion or connecting end of each flange 24 coupled to the transverse member 23. In particular, a width 36 of the free end of each flange 24 is approximately 2½ inches whereas a width 38 of the connecting end of each flange 24 connected to the transverse member 23 is illustratively slightly larger than the approximately ⅞ inch depth of the transverse member 23, as shown in FIG. 4. Illustratively, the wider foot or free end of each flange 24 provides a suitable weld surface to weld links 22 thereto. It is, however, within the scope of this disclosure to include flanges having a uniform (or non-tapered) width. Further, an illustratively height 25 of each flange 24 is approximately 4 inches.

As mentioned above, the protective chain 18 further includes connecting links 22, as shown in FIGS. 2, 3 and 4, which operate to connect each U-shaped bar 20 with each adjacent U-shaped bar 20 to form the interconnected, endless chain 18. The connecting links 18 may be sized to suitably space the bars 20 apart from one another. Illustratively, increased protection of the rubber belt 12 may be provided by spacing the bars 20 relatively close to one another. However, the bars 20 may also be spaced further distances apart from one another while still providing increased protection to the rubber belt 12.

As shown in FIG. 3, the connecting links 22 are coupled, or illustratively welded, to the free end of the flanges 24 of each bar 20. These links 22 may be coupled to the flanges 24 in a number of orientations. For example, as shown in FIG. 3, a first connecting link or set of connecting links 40 is coupled to an outer portion of the one of the flanges 24 while a second connecting link or set of connecting links 42 is coupled to an inner portion of the other flange 24. It is within the scope of this disclosure, however, to couple either the first set of connecting links 40 or the second set of connecting links 42 to either the inside or outside surface of each respective flange 24. Further, the sets 40, 42 of connecting links may be coupled to any portion of each U-shaped bar 20 (i.e., anywhere along the height 25 of one or more of the flanges 24 as well as directly to the transverse member 23) in order to couple the U-shaped bars together. As show in FIG. 2, each set 40, 42 of connecting links illustratively forms a standard linked-chain. Alternatively, pins (not shown) and bushings (not shown) may be used to connect adjacent U-shaped bars 20 to each other.

It should be appreciated that the protective chain 18 may be provided as a retrofit kit for belt-driven work machines. Indeed, a retrofit kit including the protective chain 18 and/or the rubber drive belt 12 may be installed on each side of the work machine 10. In such a way, the work machine may be operated in conditions that may otherwise prevent its use (e.g., muddy conditions, slippery conditions, or conditions with rough, jagged terrain).

While the disclosure is susceptible to various modifications and alternative forms, specific exemplary embodiments thereof have been shown by way of example in the drawings and has herein be described in detail. It should be understood, however, that there is no intent to limit the disclosure to the particular forms disclosed, but on the contrary, the intention is to cover all modifications, equivalents, and alternatives falling within the spirit and scope of the invention as defined by the appended claims.

There are a plurality of advantages of the present disclosure arising from the various features of the apparatus and methods described herein. It will be noted that alternative embodiments of the apparatus and methods of the present disclosure may not include all of the features described yet still benefit from at least some of the advantages of such features. Those of ordinary skill in the art may readily devise their own implementations of an apparatus and method that incorporate one or more of the features of the present disclosure and fall within the spirit and scope of the present disclosure.

1. A drive track system for a work machine comprising:
a drive-belt adapted to be coupled to the work machine, and
a chain engaged with an outer surface of the drive-belt and including a plurality of interconnected transverse members each extending across a width of the drive-belt.

2. The drive track system of claim 1, wherein the drive-belt is a rubber drive-belt.

3. The drive track system of claim 1, wherein the chain is metal.

4. The drive track system of claim 1, wherein the chain further includes a first flange coupled to a first outer end of each of the transverse members and a second flange coupled to a second outer end of each of the transverse members.

5. The drive track system of claim 4, wherein each of the first flange and the second flange are arranged in a non-perpendicular orientation relative to the respective transverse member to which each are coupled.

6. The drive track system of claim 5, wherein an obtuse angle is formed between each transverse member and each of the corresponding flanges.

7. The drive track system of claim 4, wherein each of the first flange and the second flange are generally perpendicular to the transverse member.

8. The drive track system of claim 4, wherein each of the first and second flanges includes a connecting end coupled to the transverse member and having a first depth and a free end having a second depth greater than the first depth.

9. The drive track system of claim 1, wherein the chain further includes a plurality of connecting links coupled to each other and to each transverse member to position the transverse members in spaced-apart relation to each other.

10. The drive track system of claim 9, wherein each connecting link is a first connecting link coupled to a first end of each transverse member and the chain further includes a second connecting link coupled to a second end of each transverse member.

11. The drive track system of claim 10, wherein the chain further includes a pair of flanges coupled to each of the transverse members, and wherein the first connecting link is coupled to an outside surface of each of one of the flanges coupled to each transverse member and the second connecting link is coupled to an inside surface of each of the other one of the flanges coupled to each transverse member.

12. A method of operating a belt-driven work machine comprising:
covering an outer surface of a rubber drive-belt of the belt-driven work machine with a metal chain including a plurality of interconnected U-shaped bars to position the rubber drive-belt within a recess defined by each U-shaped bar.

13. A chain adapted to be positioned on a rubber drive-belt of a belt-driven work machine, the chain comprising:
a plurality of interconnected U-shaped bars each including a transverse member and a pair of flanges extending downwardly from the transverse member to define a recess adapted to receive a portion of the rubber drive-belt of the belt-driven work machine therein.

14. The chain of claim 13, wherein the U-shaped bars are metal.

15. The chain of claim 13, wherein each flange of the pair of flanges of each U-shaped bar is arranged to define a non-perpendicular orientation relative to the transverse member.

16. The chain of claim 15, wherein an obtuse angle is formed between each flange and the respective transverse member to which the flange is coupled.

17. The chain of claim 13, wherein a profile of each flange is generally shaped to form a trapezoid.

18. The chain of claim 17, wherein each flange includes (i) a connecting end coupled to the transverse member and having a first width and (ii) a free end having a second width greater than the first width.

19. The chain of claim 13, further comprising a first set of connecting links coupled to a first flange of the pair of flanges of each U-shaped bar.

20. The chain of claim 19, further comprising a second set of connecting links coupled to a second flange of the pair of flanges of each U-shaped bar.
